(19) United States
(12) Patent Application Publication
(10) Pub. No.: US 2016/0370825 A1
(43) Pub. Date: Dec. 22, 2016

(54) WEARABLE MEMORY CARD HOLDER

(71) Applicants: Joice S. Ruffing, Abilene, TX (US); Juliana S. Evans, Katy, TX (US)

(72) Inventors: Joice S. Ruffing, Abilene, TX (US); Juliana S. Evans, Katy, TX (US)

(21) Appl. No.: 15/250,235

(22) Filed: Aug. 29, 2016

Related U.S. Application Data
(63) Continuation-in-part of application No. 14/460,842, filed on Aug. 15, 2014, now Pat. No. 9,429,991.
Application No. 14/460,842 is a continuation-in-part of application No. 14/181,902, filed on Feb. 17, 2014.

(51) Int. Cl. G06F 1/16; G06F 1/18

(52) U.S. Cl. CPC G06F 1/163; G06F 1/18; G06F 1/189

(57) ABSTRACT

A wearable memory card holder for positioning on a limb of a wearer may include a band for at least partially encircling the limb of the wearer, a memory card receptacle integrated with the band and configured to removably receive at least one memory card such that the at least one memory card may be removed from the receptacle of the band, and a transmitter mounted on the band and configured to wirelessly transmit data from the at least one memory card.

### CROSS-REFERENCE TO RELATED APPLICATION

This application is a continuation-in-part of U.S. patent application Ser. No. 14/460,842 entitled “Wearable Memory Card Holder” and filed Aug. 15, 2014, now U.S. Pat. No. 9,429,991; which is a continuation-in-part of U.S. patent application Ser. No. 14/181,902 entitled “Wearable Memory Card Holder” and filed Feb. 17, 2014 (abandoned); the disclosures of both of which are incorporated by reference herein in their entirety.

### FIELD

The present disclosure relates to apparel and more particularly pertains to a new wearable memory card holder for carrying one or two or more memory cards on the body of the card user in a location that is convenient for quick access while performing other tasks.

### SUMMARY

In one aspect, the present disclosure relates to a wearable memory card holder for positioning on a limb of a wearer. The holder may comprise a band for at least partially encircling the limb of the wearer and a memory card receptacle integrated with the band and configured to receive at least one memory card.

In another aspect, the disclosure relates to a wearable memory card holder for positioning on a wrist of a wearer. The holder may comprise a band configured to form a loop to removably encircle the limb of the wearer, with the band forming a loop of adjustable circumference. The holder may also comprise a memory card receptacle integrated with the band and forming a socket including a cavity with a slot opening into the cavity for receiving one or more memory cards.

In still another aspect, the disclosure relates to a system including a memory card and a wearable memory card holder that may comprise a band configured to form a loop to removably encircle the limb of the wearer, the band forming a loop of adjustable circumference. The holder may also include a memory card receptacle integrated with the band and forming a socket including a cavity with a slot opening into the cavity. The memory card may be removably received in the socket of the memory card receptacle.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of a new wearable memory card holder according to the present disclosure.

FIG. 2 is a schematic top view of the holder worn on an arm, according to an illustrative embodiment.

FIG. 3 is a schematic partial side view of the holder, according to an illustrative embodiment.

FIG. 4 is a schematic block diagram of the holder, according to an illustrative embodiment.

FIG. 5 is a schematic block diagram of another illustrative embodiment of the holder.

### DETAILED DESCRIPTION

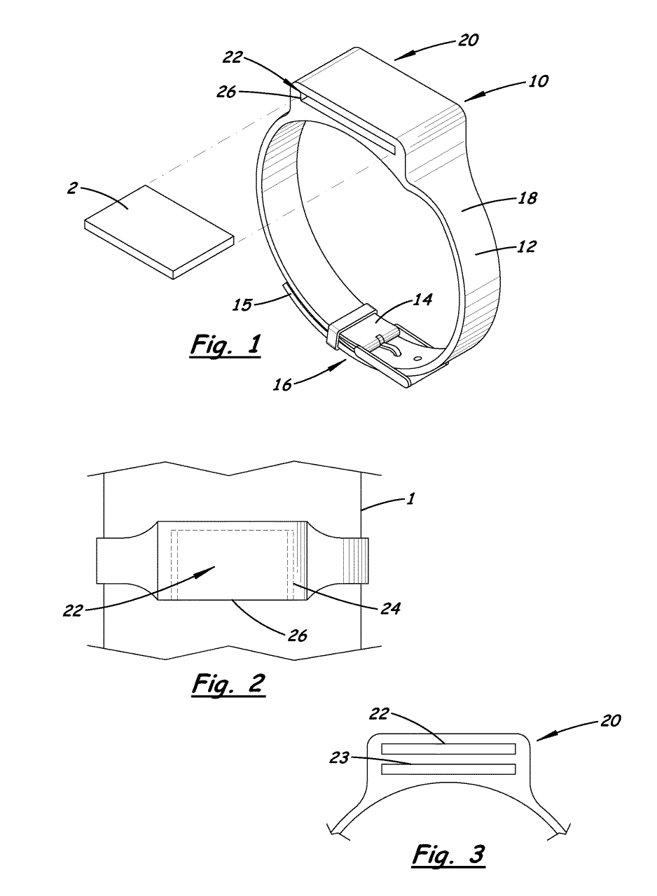

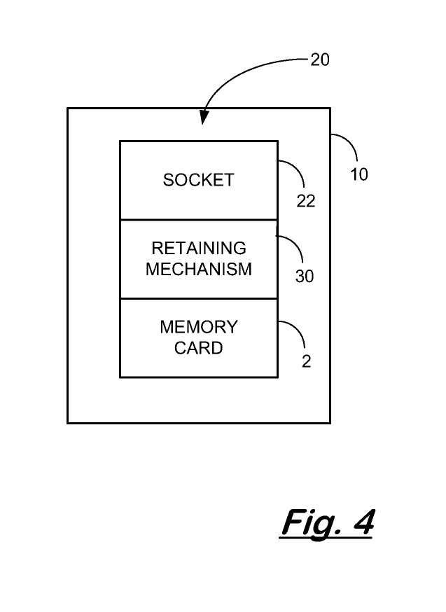

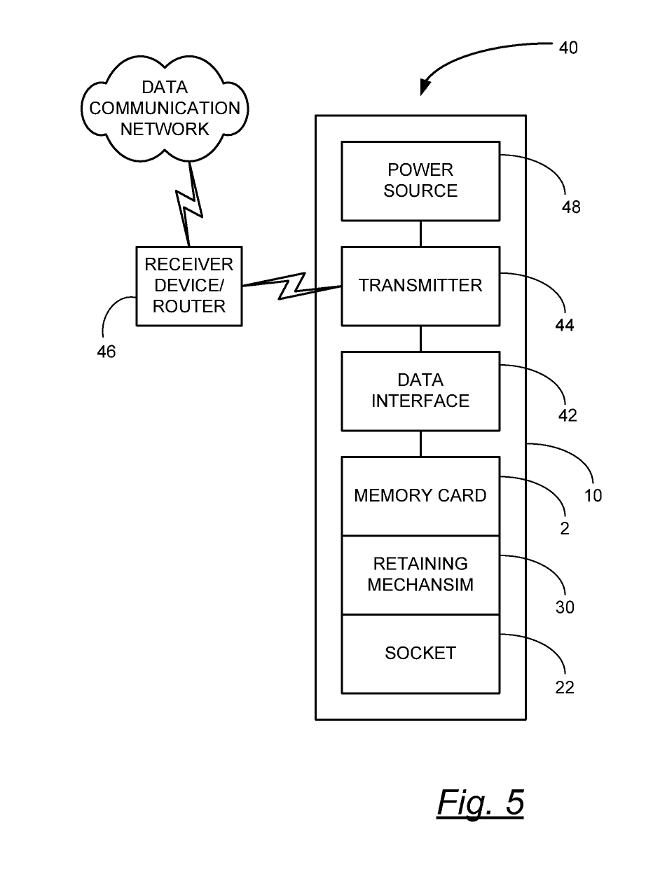

With reference now to the drawings, and in particular to FIGS. 1 through 5 thereof, a new wearable memory card holder embodying the principles and concepts of the disclosed subject matter will be described.

The applicants have recognized that, while digital photography and videography has simplified the creative process in many ways, the digital format is not without difficulties. Digital photos and videos encourage the professional photographer and videographer to take many more photos and minutes of video without have to worry about wasting film on poor shots, as poor photos and video may easily be deleted, and the digital memory cards are able to hold many more shots and minutes of video than analog film could. However, the storage of digital memory cards is not infinite, especially for photos and video taken at higher definitions, and therefore the cards do need to be changed out from the camera when full to capacity and replaced with another memory card. During photography and video filming, the interchange of memory cards can be just as interruptive as the changing of film, and even though the relatively small size of the video cards can make the cards more portable it may also make the cards more difficult to locate in a photography gear bag in a quick manner.

Applicants have also devised a solution to the problem of conveniently carrying and locating the memory cards which involves carrying the card on the body of the photographer or videographer in an easily accessible location for interchanging an empty memory card for a full memory card in the camera.

In general, the disclosure is directed to a wearable memory card holder 10 for positioning on a limb 1 of a wearer and removably receiving a memory card 2. The holder 10 may be configured to substantially encircle an arm of the wearer, such as in the forearm or wrist region of the arm. The holder may thus constitute a wrist-mountable device, and may be embodied as a bracelet.

In some greater detail, the holder 10 may comprise a band 12 for at least partially encircling the wrist of the wearer. The band 12 may form a continuous loop, although a partial or incomplete loop may also be employed. The band 12 may have opposite ends 14, 15 that are releasably connectable together to removably mount the loop on the limb of the wearer. The band 12 is preferably formed of a material that is flexible to permit the band to be flexed and curved about the wrist of the user to generally conform to the shape of the forearm of the user, although the band does not have to form a tight or snug fit about the wrist. In some embodiments, portions of the band may be relatively more flexible and other portions may be relatively less flexible, and as an example, the portions towards each of the ends 14, 15 of the band may be more flexible while a central portion in between the end portions is relatively less flexible, and may not have any flexibility at all. The releasable connection for the ends 14, 15 may be formed in any suitable connector structure 16 known to those skilled in the art such as, for example, clasps, snaps, buckles, and the like. Further, the loop may have an adjustable circumference size to accommodate different wrist sizes and may help provide a snug fit that resists inadvertent removal or loss. Illustratively the connector structure may be a conventional frame and prong configuration, although other structures may be utilized. The band 12 may have an exterior surface 18 that forms the exterior of the band. The exterior surface of the band may be decorated in any desired manner and may have many different styles from the plain and utilitarian (as illustrated in the drawings) to the pretentious.

The holder 10 may also include a memory card receptacle 20 that is configured to receive a memory card or cards 2. The receptacle 20 may be integrated with the band 12 so that the receptacle cannot be removed from the band, although the disclosure is not limited to embodiments in which the receptacle cannot be removed, and in some embodiments removability of the receptacle may be employed. The receptacle 20 may form a socket 22 that includes a cavity 24 with a slot opening 26 sized and shaped to receive at least a portion of the memory card. A memory card may be moved into a storage position with respect to the receptacle in which substantially an entirety of the card is positioned in the slot opening 26 and cavity 24 to help protect the card while the wearer acts and moves in a normal manner without concern for the holder 10 or the card 2. The storage position is not necessarily limited to a condition where the whole card is inserted into a cavity, and it should be recognized that the slot opening 26 may be located in and defined by the exterior surface 18 of the band, and may lead into the interior of the cavity 24 of the socket.

The card receptacle 20 may include a retaining mechanism 30 configured to permit the memory card to be moved into the storage portion in the socket and held in the storage position until a subsequent push on the memory card (or a lever adjacent the card) causes the mechanism to move the card from the storage portion to an eject position in which the card is at least partially ejected or moved out of the storage position which facilitates finger gripping of the card to pull the card completely out of the receptacle. Other means for retaining the card in the socket may utilized, such as those that exert a frictional grip or hold on the card that may be overcome by a sufficient degree of pulling on a portion of the card exposed out of the socket.

In some embodiments of the holder 10, the receptacle 20 may form a pair of sockets 22, 23 which are capable of simultaneously each holding one of a pair of cards in storage positions. In this configuration, additional cards 2 may be interchanged with the camera of the user.

Memory cards are available under a number of standards, including Compact Flash (CF), SmartMedia (SM), Memory Stick (MS), Multimedia Card (MMC), Secure Digital (SD), xD-Pictire Card (XD), as well as many others under standards previously developed and standards to be developed in the future. Although the memory card formats may be standardized, the size and shapes of the cards under the different standards can vary, and even within one particular memory card standard there may be “mini” and “micro” variations. To some degree the variations in size and shape may be accommodated by a single socket configuration, and the sockets commonly employed on computers for memory card readers provide enabling examples of sockets able to accept cards of different standards. Although a significant number of different memory card sizes may be accommodated by these known designs, it is possible that holders of different socket configurations may need to be employed to accommodate all of the different memory card standards.

It should be recognized that in most of the preferred embodiments of the holder, insertion of the memory card into the socket does not create an electrical contact or communication with any device that would access the circuits on the card or access the information or data stored on the card. The socket of the holder is merely provided for the purpose of providing storage and protection of the memory card between uses of the card in an electronic device that is able to electrically communicate with the circuitry of the memory card.

Some embodiments of a holder 40 may include a capability to download and transmit data, such as data files for photographs, when the memory card is inserted in the receptacle of the holder. Preferably, although not critically, the data is transmitted wirelessly from the holder 40 to a desired destination remote from the holder.

In greater detail, the holder may include a data interface 42 that is mounted on the band 12 and may be configured to read data on a memory card 2 when the card is received in the memory card receptacle 20 of the holder 40. The data interface 42 may be configured to establish a data connection with the memory card 2 when received in the socket 22 of the receptacle, such as when the card is in the storage position with respect to the receptacle 20. The data interface 42 may have any suitable configuration, but may include a plurality of electrical contacts positioned in the socket to contact the contacts that are positioned on the exterior of the memory card. The data interface may be suitably programmed and physically configured to read data from the memory card, and may also be configured to recognize the type and communication protocol for the particular type of memory card which is engaged with the receptacle 20, particularly if the data interface is designed and intended to work with memory cards of a variety of different standards.

The holder 40 may further include a transmitter 44 that is mounted on the band 12 and configured to wirelessly transmit data from a memory card 2 when the card is inserted into the memory card receptacle 20, and suitably connected to the data interface 42. The transmitter 44 may be in communication with the data interface 42 to in turn be in communication with a memory card received by the card receptacle 20, and may be able to receive data read from the memory card by the data interface when the memory card is inserted into the memory card receptacle. The transmitter 44 may be integrated into the band 12 so that the transmitter remains with the band at all times.

The transmitter 44 may be configured to communicate with a receiver 46 through wirelessly transmitted signals using any suitable communication standard. A few examples include Wi-Fi, Bluetooth, and near field communication (NFC), and typically may include standards that use relatively short range wireless communication, such as those that reach up to about 500 feet. Longer range wireless communications may require a significant amount of power that is not able to be supplied to the transmitter in a practical fashion. The receiver 46 may be any suitable receiver of signals of the protocol(s) being utilized by the transmitter 44. The receiver 46 may be associated with a network interface, which may include a wireless router, and may also interfaced with a larger data communication network such as, for example, the Internet. The transferred data may then be transmitted to other locations, including servers that function to store such information for later retrieval and is colloquially referred to as the “cloud.”

The holder 40 may also include a power source 48 that is configured to provide power to the transmitter and the data interface, as well as any other elements of the holder that require electrical power. In some embodiments, the power source 48 comprises a battery, and the battery may be of the rechargeable type or the replaceable type.

In various embodiments, the holder 40 may have similar physical features to the earlier-discussed holder 10, including and not limited to, incorporating both the receptacle 20 and the band 12. As was discussed in greater detail in reference to the receptacle 20 of the holder 10, the receptacle 20 of the holder 40 may incorporate a single socket 22, or more than one socket, such as the sockets 22 and 23 depicted in FIG. 3. As was also discussed in reference to the holder 10, in different embodiments, the band 12 may be formed integrally with the receptacle 20 or may be separable from the receptacle 20. In embodiments in which the band 12 is separable from the receptacle 20, the receptacle 20 may be capable of being coupled to any of a variety of different implementations of the band 12, among which may be implementations of the band 12 that are of different sizes such that different implementations of the band 12 may have different widths, different lengths and/or different thicknesses. Alternatively or additionally, the different implementations of the band 12 to which the receptacle 20 may be separably coupled may include implementations having different shapes and/or may include implementations fabricated from different materials.

In various embodiments, the receptacle 20 of the holder 40 may incorporate one or more of the sockets 22 and/or 23 to receive and physically retain memory cards 2 of any of a variety of physical dimensions and/or shapes, as previously discussed in reference to the receptacle 20 of the holder 10. Similarly, the receptacle 20 of the holder 40 may incorporate the retaining mechanism 30 which may employ any of a variety of techniques to physically retain a memory card 2 within one of the sockets 22 or 23. Such techniques may include, and are not limited to, friction acting on one or more surfaces of a memory card 2 with a portion of the memory card 2 caused to remain outside of the socket 22 or 23 to allow the wearer of the holder 40 to pull the memory card 2 therefrom with enough force to overcome such friction by grasping that portion between at least two digits of a hand; a retaining tray (not shown) that is slidable into and out of the socket 22 or 23 in a manner akin to a cabinet drawer to hold a memory card 2 within the tray within that socket; or a spring-biased ejecting mechanism that retains a memory card 2 within the socket 22 or 23 until a push of a button (other form of manual operation of another form of manual control) accessible to the wearer at an external location of the holder 40 triggers the use of a spring to urge the memory card 2 out of the socket 22 or 23.

In embodiments in which the holder 40 incorporates multiple sockets, the multiple sockets may include at least one of the multiple sockets that does not include the ability to electrically interface with and/or read data from a memory card 2, and at least one other of the multiple sockets that does include the ability to electrically interface with and/or read data from a memory card 2. Stated differently, in embodiments in which there are multiple ones of the sockets 22 and/or 23, at least one of the multiple sockets (e.g., the socket 22) may be configured to physically retain a memory card 2, but not to electrically interface with it, while at least one other of the multiple sockets (e.g., the socket 23) may be configured to include the data interface 42 to electrically interface with a memory card 2 and to read data therefrom. Such differences in functionality among multiple sockets may be employed to provide physical storage for one or more empty memory cards 2 (e.g., ones of the memory card 2 that have not previously been used, or that have been erased in preparation for new use), while also providing interfacing to at least one memory card 2 in which data is stored.

In various embodiments, the holder 40 may additionally incorporate a storage device (not shown) into which data read from a memory card 2 by the data interface 42 may be stored. As familiar to those skilled in the art, memory cards 2 may each have any of a wide range of storage capacities (e.g., from one or more megabytes to hundreds of gigabytes), and the storage device incorporated into the holder 40 may be configured to have a storage capacity selected to match, or to be at least be relatively similar to, storage capacities expected to be provided by one or more memory cards 2. Mores specifically, the storage device incorporated into the holder 40 may be configured to have sufficient storage capacity as to be capable of storing all data that is stored in at least one memory card 2, or more than one memory cards 2. Such storage, by the holder 40, of the data stored within one or more memory cards 2 may be employed to provide a backup to the storage of the data within those one or more memory cards 2 to prevent loss of that data in the event that any of the one or more memory cards 2 is lost or damaged. In some of such embodiments, the data interface 42 may monitor a socket or more than one socket (e.g., one or more of the sockets 22 and 23) to detect insertion of a memory card 2, and may be triggered to read the data stored in a memory card 2 for storage within the storage device incorporated into the holder 40 as a result of detecting insertion of a memory card 2 into a socket.

In various embodiments, the storing of the data stored within one or more memory cards 2 into a storage device incorporated into the holder 40 may alternatively or additionally serve to buffer such data for subsequent transmission by the transmitter 44 to the receiver 46. More specifically, such storage of data read from one or more memory cards 2 into such a storage device incorporated into the holder 40 may enable transmission to the receiver 46 at a later time when none of the one or more memory cards 2 are still coupled in any way to the holder 40. Stated differently, such embodiments of the holder 40 may serve as transfer devices to store data read from one or more memory cards 2 in preparation for subsequent transfer to the receiver 46 at a later time when all of the one or more memory cards 2 may have been removed from all sockets of the holder 40.

In various embodiments, the transmitter 44 may transmit data stored within the storage device incorporated into the holder 40 to the receiver 46 by any of a variety of wireless or cable-based couplings. As previously discussed, such transmissions may be made wirelessly in a manner that conforms to any of a variety of known standards for wireless data transmission, including and not limited to, any of the 802.11 series wireless transmission standards promulgated by the Institute of Electrical and Electronics Engineers (IEEE), Wi-Fi, Bluetooth, NFC, etc. Alternatively or additionally, such transmissions may be made via electrically and/or optically conductive cabling in a manner that may conform to any of a variety of known standards to cable-based data transmission, including and not limited to, Toslink, any of the 802.3 series of standards promulgated by IEEE for Ethernet, the 1394 standard promulgated by IEEE for FireWire, Universal Serial Bus (USB), etc.

Regardless of the nature of the wireless or cable-based coupling that is employed in such transmissions, the receiver 46 may be incorporated into any of a variety of devices, including and not limited to, a server or gateway device providing access to multiple servers, a wireless access point (WAP), a network router, a broadband cable or digital subscriber line (DSL) modem, a desktop computer or portable computer, a smartphone or tablet computer, another body-worn device, a network-attached storage (NAS) device, etc. Where the receiver 46 is incorporated into and/or externally coupled to a desktop computer, portable computer, tablet computer or smartphone, one or more of such devices may be configured to execute and/or otherwise interoperate with any of a variety of operating systems and/or other software offered by any of a variety of corporations and/or other organizations, including and not limited to, iOS offered by Apple Inc., Windows offered by Microsoft Corporation, Linux offered by a wide variety of entities, Android OS offered by Google Inc., etc. The transmitter 44 may recurringly check for a coupling (whether wireless or cabling-based) to a receiver and/or an opportunity to form a coupling with a receiver (e.g., the receiver 46), and may be triggered to transmit data earlier read from a memory card 2 and stored within the storage device incorporated into the holder 40 as a result of detection and/or formation of a coupling with a receiver.

In various embodiments, the holder 40 may incorporate one or more components that provide a user interface (UI) to the wearer, including and not limited to, one or more manually operable controls and/or visual indicators. The provision of such a UI may enable the wearer to monitor and/or control various aspects of the operation of the holder 40. More specifically, the holder 40 may incorporate one or more manually operable controls, such as buttons, lever and/or paddle switches, rotary and/or sliding variable controls, a keypad, a touchpad, a joystick, a trackball, etc. to enable the wearer to provide input to the holder 40 as part of enabling control of various aspects thereof by the wearer. Among such controlled aspects may be turning some or all of the electrically based functionality of the holder 40 on and/or off; manual triggering the reading of data stored in a memory card 2 by the data interface 42 and/or the storage of the data that is read therefrom into the storage device incorporated into the holder 40; manually triggering the formation of a wireless coupling between the transmitter 44 and a receiver (e.g., the receiver 46); and/or manual triggering the transmission of data stored within the storage device incorporated into the holder 40 by the transmitter 44 to a receiver (e.g., the receiver 46).

Alternatively or additionally, the holder 40 may incorporate one or more visual indicators, such as one or more indicator lights (e.g., one or more LEDs), a numeric and/or alphanumeric display (e.g., one or more 7-segment or 14-segment LED or LCD display components), an all-points-addressable (APA) display (e.g., a dot-matrix LED, electroluminescent or LCD display), etc. to provide indications of settings and/or status of one or more functions of the holder 40. Among such settings and/or status that may be visually presented may be indications of a current power mode of the holder 40 (e.g., a sleep mode, a lower power mode in which the transmitter 46 is disabled, a higher power mode in which all functions are enabled, etc.); indications of a current condition of a battery that may serve as the power source 48 (e.g., relatively close to depletion, fully charged, etc.); settings determining the conditions under which the reading, storage and/or transmission of data from a memory card 2 is automatically triggered; indications of status of a wireless and/or cabling-based coupling between the transmitter 44 and a receiver (e.g., connected or disconnected status, strong or weak signal, data transmission in progress, speed of data transmission, etc.); indications of speed and/or progress in the reading and storing of data from a memory card 2 and/or in transmitting data stored within the storage device incorporated into the holder 40 by the transmitter 44; indications of an error in the reading of data from a memory card 2 (e.g., a checksum error); indications of an error in storing the data in the storage device incorporated into the holder 40 (e.g., insufficient available storage space within the storage device); or indications of an error in transmission of data stored within the storage device incorporated into the holder 40 by the transmitter 44 (e.g., lack of acknowledgement of receiving a packet).

In embodiments in which the holder 40 incorporates one or more visual indicators, manual operation of a manually operable control may be required to cause the one or more visual indicators to present indications of status and/or settings. This may be done as an approach to conserving power provided by the power source 48 in embodiments in which the power source 48 is a battery or other type of power source with a relatively limited capacity to provide electric power. Alternatively or additionally, in embodiments in which the holder 40 incorporates one or more visual indicators, the one or more visual indicators may include a touch-screen display (e.g., a dot matrix display incorporating touch sensing capabilities) based on any of a variety of possible combinations of display and touch sensing technologies. This may be done in addition to or in lieu of the holder 40 incorporating one or more physically distinct manually operable controls. As familiar to those skilled in the art, graphical representations of various controls may be visually presented on such a touch-screen display to enable manual entry of input to the holder 40 by the wearer by touching the locations at which those representations of controls are visually presented. Alternatively or additionally, in embodiments in which the holder 40 incorporates one or more visual indicators, the one or more visual indicators may visually present the time of day, day of the week and/or date (e.g., may visually present a representation of a calendar, and/or of a circular analog watch face that may include representations of a rotating hour hand and/or a rotating minute hand). Alternatively or additionally, in embodiments in which the holder 40 incorporates one or more visual indicators, the one or more visual indicators may visually present a timer that may be operable by the wearer to time an activity of the wearer (e.g., time spent using a camera to capture photos and/or video at a photo session or other event), where the timer functionality is controllable through one or more physically distinct manually operable controls that may be incorporated into the holder 40 and/or through visual representations of controls supported with touch-screen functionality of the one or more visual indicators.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A wearable memory card holder for positioning on a limb of a wearer, the holder comprising:
a band for at least partially encircling the limb of the wearer;
a memory card receptacle integrated with the band and configured to removably receive at least one memory card such that the at least one memory card may be removed from the receptacle of the band; and
a transmitter mounted on the band and configured to wirelessly transmit data from the at least one memory card.

2. The holder of claim 1 additionally comprising a data interface mounted on the band and configured to read data on a memory card received in the memory card receptacle, the data interface being in communication with the transmitter.

3. The holder of claim 2 wherein the data interface is configured to establish a data connection with the memory card when received in the memory card receptacle.

4. The holder of claim 1 wherein the transmitter is configured to communicate with a receiver associated with a network interface.

5. The holder of claim 1 additionally comprising a power source on the band configured to provide power to the transmitter.

6. The holder of claim 5 wherein the power source comprises a rechargeable battery.

7. The holder of claim 1 wherein the band forms a continuous loop.

8. The holder of claim 1 wherein the band forms a loop of adjustable circumference.

9. The holder of claim 1 wherein the receptacle forms a socket including a cavity with a slot opening into the cavity.

10. The holder of claim 9 wherein the card receptacle includes a retaining mechanism configured to permit the memory card to be moved into the socket into a storage position of the card and held in the storage position until a subsequent finger push causes the mechanism to at least partially eject the memory card from the socket to an eject position.

11. A system including:
a memory card; and
a wearable memory card holder comprising:
a band configured to form a loop to removably encircle a limb of a wearer, the band forming a loop of adjustable circumference;
a memory card receptacle inseparably integrated with the band and forming a socket including a cavity with a slot opening into the cavity;
a transmitter integrated with the band and configured to wirelessly transmit data from a memory card; and
wherein the memory card is removably received in the socket of the memory card receptacle such that the memory card is removable from the band without removing the receptacle from the band.

12. The system of claim 11 wherein the card receptacle includes a retaining mechanism configured to permit the memory card to be moved into the socket into a storage position and held in the storage position until a subsequent finger push causes the mechanism to at least partially eject the memory card from the socket to an eject position.

13. The system of claim 11 wherein the receptacle forms two of the sockets for holding two memory cards.

14. The system of claim 11 additionally comprising a data interface mounted on the band and configured to read data on a memory card received in the memory card receptacle, the data interface being in communication with the transmitter.

15. The system of claim 14 wherein the data interface is configured to establish a data connection with the memory card when received in the memory card receptacle.

16. The system of claim 11 wherein the transmitter is configured to communicate with a receiver associated with a network interface.

17. The system of claim 11 additionally comprising a power source on the band configured to provide power to the transmitter.

18. The system of claim 11 wherein the memory card receptacle includes two of the sockets configured to hold two memory cards independent of each other, each socket including a separate slot opening, the slot openings of both sockets being located in an edge face of one of two opposite lateral edges of the band to permit insertion and removal of memory cards in the sockets using a same hand motion for both of the sockets; and
wherein the band has a central portion and a pair of side portions extending from the central portion, the sockets of the memory card receptacle being positioned in the central portion, the central portion having a lateral width and a longitudinal length slightly larger than a width and length of the socket.

19. A wearable memory card holder for positioning on a limb of a wearer, the holder comprising:
a band for at least partially encircling the limb of the wearer;
a memory card receptacle inseparably integrated with the band and configured to removably receive at least one memory card such that the at least one memory card may be removed from the band without removing the receptacle from the band;
a transmitter integrated with the band and configured to wirelessly transmit data from the at least one memory card;
a power source integrated with the band and configured to provide power to the transmitter; and
a data interface mounted on the band and configured to read data on the at least one memory card received in the memory card receptacle, the data interface being in communication with the transmitter, the data interface being configured to establish a data connection with the at least one memory card when received in the memory card receptacle.
